(19) United States
(12) Patent Application Publication
(10) Pub. No.: US 2020/0404290 A1
(43) Pub. Date: Dec. 24, 2020

(54) VIDEO ENCODING APPARATUS AND VIDEO ENCODING METHOD

(71) Applicant: Novatek Microelectronics Corp., Hsinchu (TW)

(72) Inventors: Xin Huang, Xi'an (CN); Fan-Di Jou, Hsinchu County (TW)

(73) Assignee: Novatek Microelectronics Corp., Hsinchu (TW)

(21) Appl. No.: 17/009,727

(22) Filed: Sep. 1, 2020

Related U.S. Application Data
(62) Division of application No. 15/723,200, filed on Oct. 3, 2017.

(30) Foreign Application Priority Data
Sep. 5, 2017 (CN) 201710791138.1

(51) Int. Cl. H04N 19/167; H04N 19/124; H04N 19/139; H04N 19/172; H04N 19/52; H04N 19/61; H04N 19/91

(52) U.S. Cl. CPC H04N 19/167; H04N 19/124; H04N 19/139; H04N 19/119; H04N 19/52; H04N 19/61; H04N 19/91; H04N 19/172

(57) ABSTRACT

A video encoding apparatus and a video encoding method are provided. The video encoding apparatus comprises an encoding circuit and a region of interest (ROI) determination circuit. The encoding circuit performs a video encoding operation on an original video frame to generate an encoded video frame. The encoding information is generated by the video encoding operation during an encoding process. The ROI determination circuit reuses the encoding information generated by the video encoding operation to identify one or more ROI objects according to the initial ROI and generates one or more dynamic ROIs for tracking the one or more ROI objects within a current video frame for any one of a plurality of sequential video frames following the original video frame.

### CROSS-REFERENCE TO RELATED APPLICATION

This application is a divisional application of and claims the priority benefit of a prior application Ser. No. 15/723,200, filed on Oct. 3, 2017. The prior application Ser. No. 15/723,200 claims the priority benefit of China application serial no. 201710791138.1, filed on Sep. 5, 2017. The entirety of the above-mentioned patent application is hereby incorporated by reference herein and made a part of this specification.

### BACKGROUND

### Field of the Invention

The invention is directed to a video processing system and more particularly, to a video encoding apparatus and a video encoding method thereof.

### Description of Related Art

Video monitoring is an application of a video system. In order to provide high-resolution videos, a conventional video monitoring apparatus adopts an encoding strategy with high video quality for a global area of a video frame. Accordingly, it can be considered that the encoding strategy with high video quality consumes a lot of software/hardware resources (e.g., encoding operation resources, transmission bandwidths and storage spaces). To save the software/hardware resources, the conventional video monitoring apparatus may adopts an encoding strategy with low video quality for the global area of the video frame. The video frame with low video quality may cause difficult identification in some important details (e.g., a human face, a vehicle license plate number and so on) in an image.

### SUMMARY

The disclosure provides a video encoding apparatus and a video encoding method for identifying one or more region of interest (ROI) objects according to an initial ROI and generating one or more dynamic ROIs for tracking one or more ROI objects within a current video frame.

According to an embodiment of the invention, a video encoding apparatus is provided. The video encoding apparatus includes an encoding circuit and a region of interest (ROI) determination circuit. The encoding circuit is configured to perform a video encoding operation on an original video frame to generate an encoded video frame. At least one encoding information is generated by the video encoding operation during an encoding process. The ROI determination circuit is coupled to the encoding circuit to receive the encoding information. The ROI determination circuit is configured to obtain an initial ROI within the original video frame and reuse the encoding information generated by the video encoding operation to identify one or more ROI objects according to the initial ROI and generate one or more dynamic ROIs for tracking the one or more ROI objects within a current video frame. The current video frame can be any one of a plurality of sequential video frames following the original video frame. Wherein, each of the ROI objects appears in the initial ROI within the current video frame or in the initial ROI of at least one video frame in the sequential video frames before the current video frame.

According to an embodiment of the invention, a video encoding method is provided. The video encoding method includes: performing a video encoding operation on an original video frame by an encoding circuit to generate an encoded video frame, wherein at least one encoding information is generated by the video encoding operation during an encoding process; obtaining an initial ROI within the original video frame; and reusing the encoding information generated by the video encoding operation to identify one or more ROI objects according to the initial ROI and generate one or more dynamic ROIs for tracking the one or more ROI objects within a current video frame. The current video frame can be any one of a plurality of sequential video frames following the original video frame. Wherein, each of the ROI objects appears in the initial ROI within the current video frame or in the initial ROI of at least one video frame in the sequential video frames before the current video frame.

According to an embodiment of the invention, a video encoding method is provided. The video encoding method includes: generating an initial ROI within an original video frame; identifying one or more ROI objects according to the initial ROI; and generating one or more dynamic ROIs for tracking the one or more ROI objects within a current video frame. The current video frame can be any one of a plurality of sequential video frames following the original video frame. Wherein, each of the ROI objects appears in the initial ROI within the current video frame or in the initial ROI of at least one video frame in the sequential video frames before the current video frame.

Based on the above, in the video encoding apparatus and the video encoding method of some embodiments of the invention, one or more ROI objects can be identified according to the initial ROI. The video encoding apparatus can generate one or more dynamic ROIs for tracking the ROI objects within the current video frame. In some embodiments of the invention, the video encoding apparatus and the video encoding method can simultaneously achieve tracking the objects passing through the initial ROI and dynamically adjusting a respective size and/or a respective shape of at least one actual ROI (the region(s) where the objects are actually located, or the dynamic ROI(s)). The video encoding operation can be performed on the ROI and other regions within the current video frame by using different encoding strategies. For example, finer encoding process can be performed for the dynamic ROI(s) rather than the whole initial ROI. Thus, the video encoding apparatus and the video encoding method can improve visual quality of the ROI objects and simultaneously meet design requirements for software/hardware resources (e.g., encoding operation resources, transmission bandwidths and storage spaces).

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is schematic circuit block diagram illustrating a video encoding apparatus according to an embodiment of the invention.

FIG. 2 is flowchart illustrating a video encoding method according to an embodiment of the invention.

FIG. 3 is a schematic diagram illustrating operation of the region of interest (ROI) determination circuit depicted in FIG. 1 according to an embodiment of the invention.

FIG. 4A to FIG. 4D are schematic diagrams illustrating different scenarios of the initial ROI according to an embodiment of the invention.

FIG. 5 is schematic circuit block diagram illustrating the encoding circuit and the ROI determination circuit depicted in FIG. 1 according to an embodiment of the invention.

FIG. 6 is a schematic diagram illustrating the adjustment of the quantization step size and the rounding offset according to an embodiment of the invention.

FIG. 7 is flowchart illustrating a video encoding method according to another embodiment of the invention.

FIG. 8 to FIG. 11 are schematic diagrams illustrating a scenario of the initial ROI according to an embodiment of the invention.

### DESCRIPTION OF EMBODIMENTS

A term “couple” used in the full text of the disclosure (including the claims) refers to any direct and indirect connections. For instance, if a first device is described to be coupled to a second device, it is interpreted as that the first device is directly coupled to the second device, or the first device is indirectly coupled to the second device through other devices or connection means. Moreover, wherever possible, components/members/steps using the same referral numerals in the drawings and description refer to the same or like parts. Components/members/steps using the same referral numerals or using the same terms in different embodiments may cross-refer related descriptions.

In some embodiments, encoding information may be reused to generate dynamic ROIs. The dynamic ROIs can have dynamically-varied positions, shapes, areas, and/or existences. The dynamic ROIs can allow ROI objects to be continuously tracked. The ROI objects can be either idle or moving. In addition, the ROI objects can be the same (original) objects or new objects. The positions, shapes, areas, and/or existences of the dynamic ROIs can be dynamically-varied to cover the moving or new ROI objects. Different frames can have the same or different dynamic ROIs containing the same or different ROI object(s).

In some implementations, the dynamic ROIs can be processed with a different encoding strategy to have better video quality. The rest region in the frame can be processed to have normal or relatively-low video quality. In such implementations, the dynamic ROIs having dynamically-varied positions, shapes and/or existences can lead to more efficient usage of system resources focused on the dynamic ROIs and thus achieve better video quality.

A video codec is capable of effectively encoding or decoding a high-resolution or high-quality video content. The codec refers to a hardware apparatus, firmware or a software program capable of performing a video encoding operation and/or a video decoding operation on a video input signal video input signal.

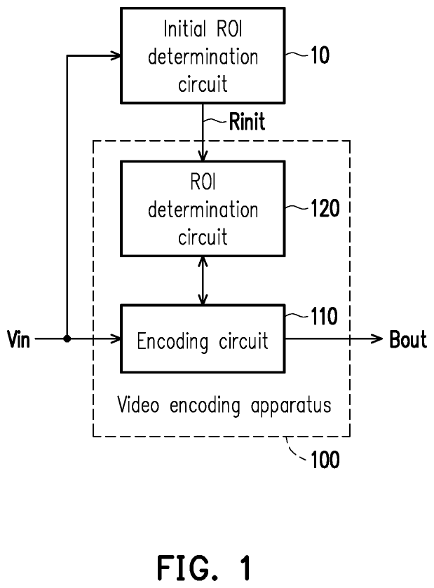

FIG. 1 is schematic circuit block diagram illustrating a video encoding apparatus 100 according to an embodiment of the invention. The video encoding apparatus 100 includes an encoding circuit 110. The encoding circuit 110 receives a video input signal Vin. The video input signal Vin includes a plurality of sequential video frames. The encoding circuit 110 may perform a video encoding operation on an original video frame of the video input signal Vin to generate an encoded video frame. The encoding circuit 110 may output the encoded video frame as a bit stream output signal Bout. The implementation manner of the video encoding operation is not limited in the present embodiment. For instance, according to a design demand, the video encoding operation may be a conventional video encoding method or any other video encoding methods. The encoding circuit 110 may perform the video encoding operation on different regions within the current video frame by using different encoding strategies, and thus, different regions have different video quality (e.g., resolution and/or other video characteristics).

During an encoding process of the video encoding operation, the encoding circuit 110 may generate encoding information. In some embodiments, the encoding information may include one or a plurality of texture information of largest coding unit (LCU), coding unit (CU) depth information, prediction unit (PU) size information, transform unit (TU) size information, motion vector information and advanced motion vector prediction (AMVP) information.

According to application demands, the video encoding apparatus 100 may be disposed in a computer, a smart phone, a digital video camera, a server or other electronic apparatuses. For instance, the video encoding apparatus 100 may be applied in “video monitoring.” The video encoding apparatus 100 adopts a region of interest (ROI) technique, i.e., an intelligent video encoding (IVE) technique. One reason is to increase visual quality of important objects and simultaneously meet design requirements for software/hardware resources (e.g., encoding operation resources, transmission bandwidths and storage spaces). Thus, an ROI determination circuit 120 is disposed in the video encoding apparatus 100. They ROI determination circuit 120 can define or determine ROI(s) which can include an initial ROI. An initial ROI determination circuit 10 may, for example, provide a setting interface for a user or a former stage circuit (not shown) to define an initial ROI (or a plurality of initial ROIs) Rinit in an original video frame and provide the initial ROI Rinit to the ROI determination circuit 120. According to a design demand, the initial ROI determination circuit 10 may be a conventional setting interface circuit or any other setting interface circuit. The ROI determination circuit 120 then can determine one or more dynamic ROIs based on the initial ROI. The determination can be made by using the encoding information.

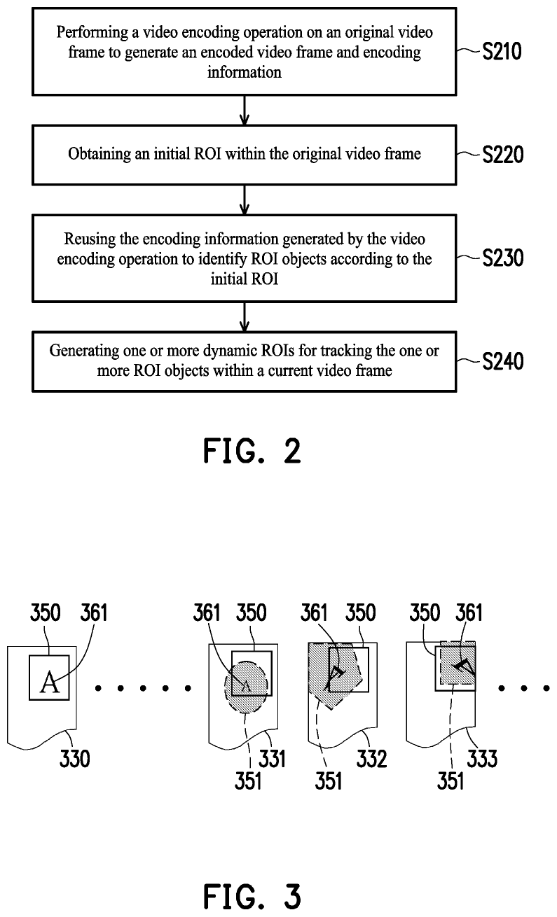

FIG. 2 is flowchart illustrating a video encoding method according to an embodiment of the invention. The video encoding method can be applied to the video encoding apparatus 100 of FIG. 1 but not limited thereto. For purpose of explanation only, the embodiment of FIG. 2 is described with the video encoding apparatus 100 of FIG. 1. Refer to FIG. 1 and FIG. 2. In step S210, the encoding circuit 110 may also perform an video encoding operation on an original video frame in a video input signal Vin to generate an encoded video frame (i.e., a bit stream output signal Bout). At least one encoding information, e.g., LCU texture information, CU depth information, PU size information, TU size information, motion vector information and/or AMVP information, may be generated by the video encoding operation during the encoding process. The ROI determination circuit 120 is coupled to the encoding circuit 110 to receive the encoding information. Each of the encoding information is information provided by the encoding circuit 110, without being additionally calculated by the ROI determination circuit 120.

A size of an LCU is, for example, 64*64 pixels, and an actual size of a CU depends on an encoding strategy adopted by a video codec. The ROI determination circuit 120 may determine whether there is an object in a specific region according to the LCU texture information and the CU depth information (indicating which layer the LCU is grouped to). The ROI determination circuit 120 may determine whether there is a complicated object in a specific region according to the PU size information and the TU size information. The motion vector information is used to express a relative motion relation between one video frame and another video frame. Thus, the ROI determination circuit 120 may determine whether there is a moving object in a specific region according to the motion vector information. The ROI determination circuit 120 may determine a state of a current motion vector according to the AMVP information.

In step S220, the ROI determination circuit 120 may obtain the initial ROI Rinit from the initial ROI determination circuit 10. Namely, the ROI determination circuit 120 may set an initial ROI within the original video frame, as illustrated in FIG. 3. For any video frame (i.e., a current video frame) among a plurality of sequential video frames after the original video frame, the ROI determination circuit 120 may reuse the encoding information (e.g., LCU texture information, CU depth information, PU size information, TU size information, motion vector information and/or AMVP information) generated by the video encoding operation to identify one or more ROI objects within the initial ROI (step S230) and generate one or more dynamic ROIs for tracking the one or more ROI objects within the current video frame (step S240). For example (but not limited to), the ROI determination circuit 120 may, in step S230, generate mark information for marking respective positions of the ROIs based on the encoding information.

According to a design demand, the ROI objects may be moving objects, human faces, vehicle license plate numbers, specific colors, specific geometric shapes or other ROI objects. The ROI determination circuit 120 may inform the encoding circuit 110 of positions of the dynamic ROIs containing the ROI objects. The ROI object can be identified based on the initial ROI. The ROI object can be an object which stays or passes through the initial ROI in any one of the video frames including the original video frame and the sequential frames. More specifically, the ROI object may include one or more of following ROIs: at least one ROI object initially appearing in the initial ROI and staying in the initial ROI, at least one ROI object initially appearing in the initial ROI and leaving the initial ROI, at least one ROI object initially not appearing in the initial ROI, but entering and staying in the initial ROI, and at least one ROI object initially not appearing in the initial ROI but passing through the initial ROI.

In an actual video motoring application, the ROIs are regions considered more important or requiring higher display quality. In contrast, other regions (e.g., backgrounds) other than the ROIs containing the ROI objects within the current video frame are usually less important (less interested). The encoding circuit 110 may perform the video encoding operation on the dynamic ROIs within the current video frame by using a first encoding strategy to maintain (or increase) visual quality of the ROI objects. In order to save network bandwidths and storage spaces, the encoding circuit 110 may perform the video encoding operation on other regions (i.e., the less interested regions, e.g., backgrounds) within the current video frame by using a second encoding strategy. The first encoding strategy is different from the second encoding strategy. Video quality corresponding to the first encoding strategy is more preferable (or higher) than video quality corresponding to the second encoding strategy. From a perspective of transmission bandwidths, an amount of data transmission using the second encoding strategy (which is, for example, an encoding strategy with a large compression ratio and a high distortion degree) may be less than an amount of data transmission using the first encoding strategy (which is, for example, an encoding strategy with a small compression ratio and a low distortion degree). The encoding circuit 110 may applies the first encoding strategy in the dynamic ROIs where the ROI objects are located to increase the video quality and applies the second encoding strategy in other regions other than those containing the dynamic ROIs to save bandwidth resources. The video encoding operation is performed in different regions by using different encoding strategies, and thereby, the video encoding apparatus 100 may increase the visual quality of the ROI objects and simultaneously meet the design requirements for the software/hardware resources (e.g., encoding operation resources, transmission bandwidths and storage spaces).

For instance (but not limited to), the video encoding apparatus 100 may be applied in traffic flow monitoring and tracking. When a vehicle (i.e., an ROI object) is within the initial ROI, the ROI determination circuit 120 may reuse the encoding information generated by the encoding circuit 110 to identify the vehicle and generate a corresponding dynamic ROI for tracking the vehicle. The dynamic ROI may exceed the range of the initial ROI along with the movement of the vehicle. In a condition that a plurality of vehicles are within an initial ROI, the number of the dynamic ROIs may be plural. As the ROI determination circuit 120 repeatedly uses the encoding information of the encoding circuit 110, computation cost of the ROI determination circuit 120 may be effectively reduced.

FIG. 3 is a schematic diagram illustrating operation of the ROI determination circuit 120 depicted in FIG. 1 according to an embodiment of the invention. The ROI determination circuit 120 may set an initial ROI 350 within the original video frame 330 and any one of a plurality of sequential video frames (e.g., any one of video frames 331, 332 and 333 illustrated in FIG. 3) following the original video frame 330. With the use of the encoding information provided by the encoding circuit 110, the ROI determination circuit 120 may identify one or more ROI objects (e.g., an ROI object 361 illustrated in FIG. 3) within the initial ROI 350 for any video frame (e.g., the video frame 330, 331, 332 or 333 illustrated in FIG. 3). The ROI determination circuit 120 may generate one or more dynamic ROIs (e.g., a dynamic ROI 351 illustrated in FIG. 3) for tracking the ROI object 361 within a current video frame (e.g., the video frame 330 illustrated in FIG. 3).

As illustrated in FIG. 3, the initial ROI 350 is a fixed window (which is a region with a fixed position) in the video frame. The dynamic ROI 351 is a dynamically-varying area determined by a shape of the ROI object 361. Namely, a size and a shape of the dynamic ROI 351 change with an actual size and shape of the ROI object 361. For instance, when the vehicle (i.e., the ROI object 361) within a monitoring range turns, the shape of the corresponding dynamic ROI 351 also changes. When the vehicle (i.e., the ROI object 361) leaves a captured position, i.e., the ROI object 361 becomes small, the corresponding dynamic ROI 351 also becomes small. When the vehicle (i.e., the ROI object 361) approaches the captured position, i.e., the ROI object 361 becomes large, the corresponding dynamic ROI 351 also becomes large. The ROI object 361 may be in any size and any shape, and thus, the corresponding dynamic ROI 351 may also be in any size and any shape. The size and the shape of the dynamic ROI 351 may change with the size and the shape of the ROI object 361. Thereby, waste of bandwidth resources may be reduced, and usage efficiency of bandwidth resources may be increased, while the design requirements for video quality of the ROI object 361 may be satisfied.

In the embodiment illustrated in FIG. 3, each ROI object 361 appears in the initial ROI 350 within the current video frame or in the initial ROI 350 of at least one video frame among the sequential video frames before the current video frame. In other words, if the ROI object 361 is once identified in the initial ROI 350 by the ROI determination circuit 120, the ROI determination circuit 120 keeps tracking the ROI object 361 by creating the dynamic ROI 351 no matter whether the ROI object 361 has left the initial ROI 350 or not.

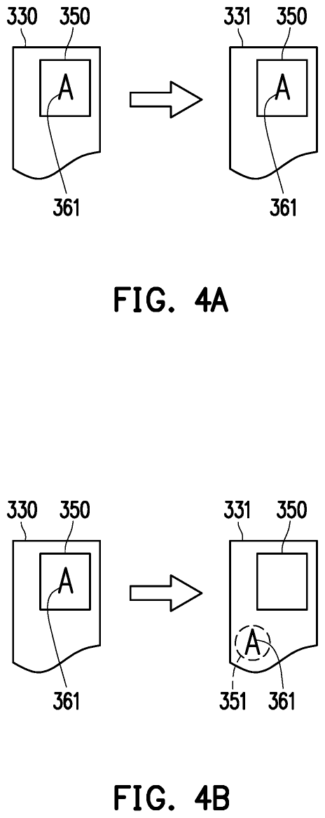

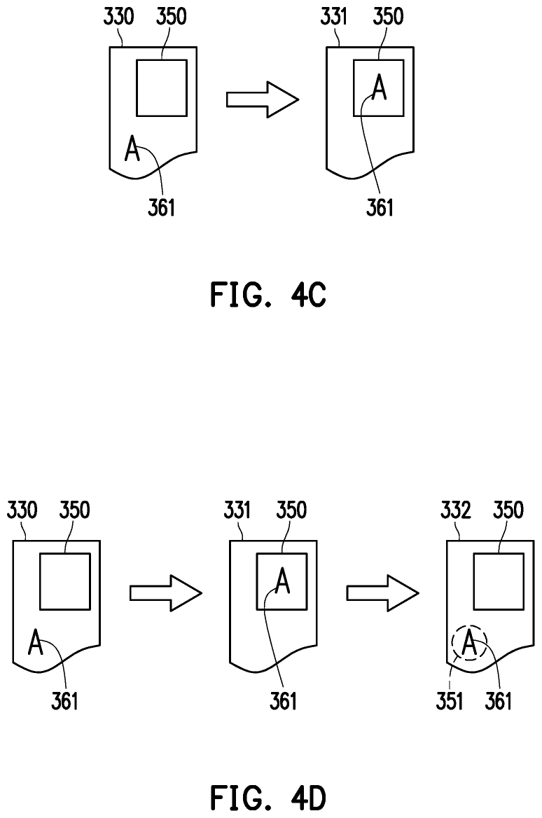

FIG. 4A to FIG. 4D are schematic diagrams illustrating different scenarios of the initial ROI 350 according to an embodiment of the invention. The ROI object 361 illustrated in FIG. 3 may include one or more objects illustrated in FIG. 4A to FIG. 4D. Referring to FIG. 4A, the ROI object 361 may be at least one ROI object initially appearing in the initial ROI 350 and then staying in the initial ROI 350. Referring to FIG. 4B, the ROI object 361 may be at least one ROI object initially appearing in the initial ROI 350 and then leaving the initial ROI 350. Referring to FIG. 4C, the ROI object 361 may be at least one ROI object initially not appearing in the initial ROI 350, but then entering and staying in the initial ROI 350. Referring to FIG. 4D, the ROI object 361 may be at least one ROI object initially not appearing in the initial ROI 350, but then passing through the initial ROI 350 and leaving the initial ROI 350. In addition, the ROI object 361 may encounter a separation condition, for example, a passenger (or passengers) gets (or get) off the vehicle (i.e., separation of a person (persons) and the vehicle). In some other scenarios, the ROI object 361 may also encounter a combination condition, for example, a passenger (or passengers) gets (or get) on the vehicle (i.e., combination of a person (persons) and the vehicle). Based on the separation or combination of multiple ROI objects 361, the corresponding dynamic ROIs 351 may also be separated or combined.

The ROI determination circuit 120 illustrated in FIG. 1 may calculate a confidence value of a current coding unit (CU) based on the encoding information provided by the encoding circuit 110 and determine whether the current CU is located within the dynamic ROI 351 according to the confidence value. The calculation method of the confidence value is not limited in the present embodiment. For instance, the ROI determination circuit 120 may calculate the confidence value Nc of the current CU by using Equation 1 below. The confidence value Nc is a value ranging from 0 to 1. The ROI determination circuit 120 may compare the confidence value Nc with a threshold to determine whether the current CU is located within the dynamic ROI 351. When the confidence value Nc is greater than the threshold, the ROI determination circuit 120 may determine that the current CU is an ROI block (i.e., the current CU is located within the dynamic ROI 351). When the confidence value Nc is less than the threshold, the ROI determination circuit 120 may determine that the current CU is not an ROI block (i.e., the current CU is not located within the dynamic ROI 351). The threshold may be determined according to a design demand.

Nc=1/[1+exp(−ΣⱼWⱼxⱼ−b)] Equation 1

In Equation 1, exp( ) refers to an exponential function with e as a base, Wⱼ is a weight, xⱼ is the encoding information provided by the encoding circuit 110, and b is an offset parameter. The encoding information xⱼ may be information generated by the encoding circuit 110 during the encoding process. In the present embodiment, the encoding information xⱼ includes CU depth information, TU size information, PU size information, motion vector information, variation information of a current block, mark information of a fixed ROI, a confidence value Nc of a reference block and/or other encoding information. By inputting the encoding information into Equation 1, optimized weight parameter wⱼ and offset parameter b may be obtained after training or experience of optimization settings by a certain amount of machine learning. The ROI determination circuit 120 determines whether to adjust the encoding parameters of the encoding circuit 110 according to the confidence value Nc, thereby improving the video quality after compression is performed.

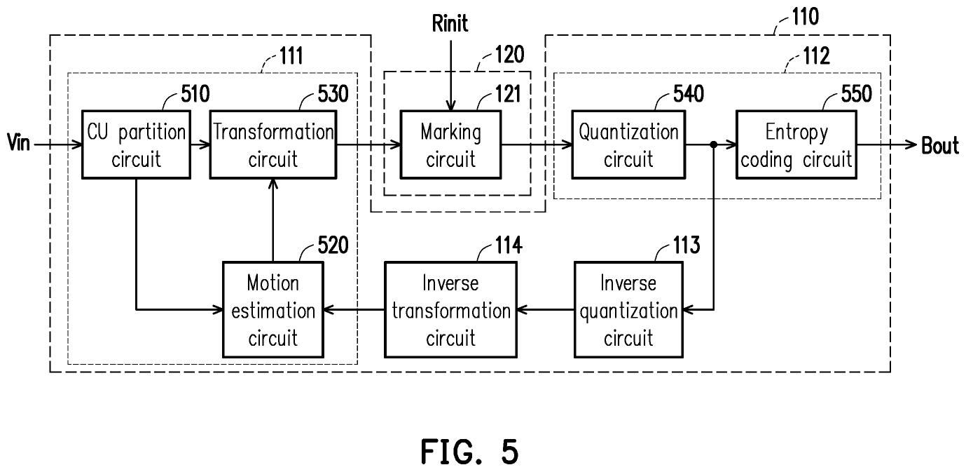

FIG. 5 is schematic circuit block diagram illustrating the encoding circuit 110 and the ROI determination circuit 120 depicted in FIG. 1 according to an embodiment of the invention. In the present embodiment, the encoding circuit 110 includes a partition circuit 111, a coding circuit 112, an inverse quantization circuit 113 and an inverse transformation circuit 114, and the ROI determination circuit 120 includes a marking circuit 121. The marking circuit 121 is coupled to the partition circuit 111 of the encoding circuit 110 to receive the encoding information, such as LCU texture information, CU depth information, PU size information, TU size information, motion vector information and/or AMVP information. The marking circuit 121 may set the initial ROI within the video frame according to the initial ROI Rinit provided by the initial ROI determination circuit 10. The marking circuit 121 may mark a CU within the one or more dynamic ROIs according to the encoding information. A video indicator of the marked CU will be increased to facilitate increasing video quality of the CU within the dynamic ROIs. The marking circuit 121 generates mark information for marking respective positions of the one or more dynamic ROIs according to the encoding information and provides the mark information to the coding circuit 112.

The partition circuit 111 illustrated in FIG. 5 performs a video partition operation on the original video frame to generate the encoding information to the marking circuit 121. The coding circuit 112 is coupled to the marking circuit 121 to receive the mark information. According to the mark information, the coding circuit 112 may adjust at least one parameter and perform a coding operation according to the adjusted parameter to generate the encoded video frame as the bit stream output signal Bout.

In the embodiment illustrated in FIG. 5, the partition circuit 111 includes a CU partition circuit 510, a motion estimation circuit 520 and a transformation circuit 530. The CU partition circuit 510 receives the original video frame and performs a CU partition operation on the original video frame to generate CU depth information. According to a design demand, the CU partition operation may be a conventional CU partition operation or any other CU partition operation. The motion estimation circuit 520 is coupled to the CU partition circuit 510 to receive the CU depth information. According to the CU depth information, the motion estimation circuit 520 performs a PU partition operation and a motion estimation operation on the original video frame to generate PU size information and motion vector information. The motion estimation circuit 520 may determine the state of the current motion vector according to the AMVP information. With the use of relation between spatial and temporal motion vectors, the motion estimation circuit 520 may create a candidate list of predictive motion vectors for a current PU and then, select a best predictive motion vector from the candidate list. According to a design demand, the PU partition operation may be a conventional PU partition operation or any other PU partition operation, and the motion estimation operation may be a conventional motion estimation operation or any other motion estimation operation. The transformation circuit 530 is coupled to the CU partition circuit 510 to receive the CU depth information. The transformation circuit 530 is coupled to the motion estimation circuit 520, to receive the PU size information and the motion vector information. According to the CU depth information, the PU size information and the motion vector information, the transformation circuit 530 may perform a TU partition operation on the original video frame to generate TU size information. According to a design demand, the TU partition operation may be a conventional TU partition operation or any other TU partition operation. The CU depth information, the PU size information, the TU size information and/or the motion vector information may be transmitted to the marking circuit 121 to serve as the encoding information.

In the embodiment illustrated in FIG. 5, the coding circuit 112 includes a quantization circuit 540 and an entropy coding circuit 550. The quantization circuit 540 is coupled to the marking circuit 121 to receive the mark information. The quantization circuit 540 adjusts the at least one parameter according to the mark information and performs a quantization operation on the CU according to the at least one parameter to generate a quantized frame. The quantization circuit 540 provides the quantized frame to the entropy coding circuit 550 and the inverse quantization circuit 113.

$$Z ( i , j ) = sign ( C ( i , j ) ) \times ⌊ \frac{\vert C ( i , j ) \vert + Δ}{q} ⌋ \qquad Equation 2$$

According to a design demand, the quantization operation may be a conventional quantization operation or any other quantization operation. For instance, the quantization operation may include Equation 2 above. In Equation 2, sign( ) represents a sign function, C(i,j) represents a parameter before the quantization, Z(i,j) represents a quantized parameter, q represents a quantization step size, and A represents a rounding offset.

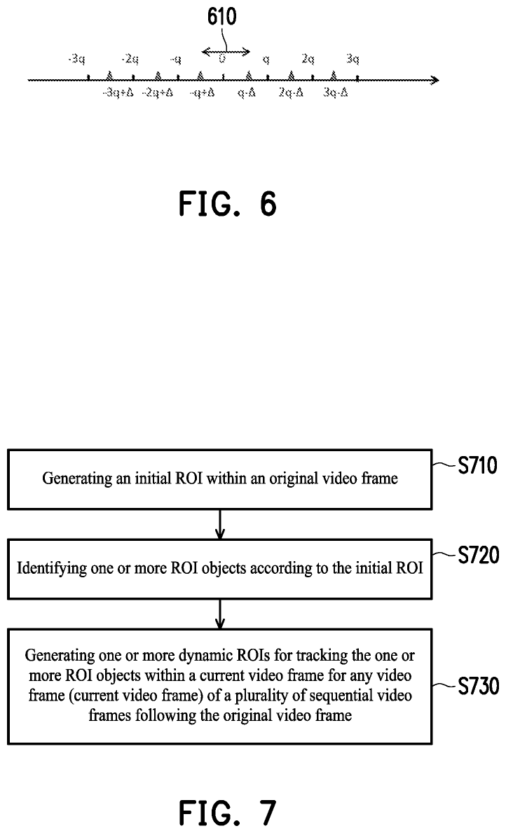

FIG. 6 is a schematic diagram illustrating the adjustment of the quantization step size and the rounding offset according to an embodiment of the invention. In video encoding, for a region that is insensitive to “visual distortion” (which refers to a region with less distortion sensitivity), the quantization circuit 540 may enlarge a quantization step size thereof. For a sensitive region, the quantization circuit 540 may reduce a quantization step size thereof. In comparison with the use of a unified (fixed) quantization step size, adjusting the quantization step size may allow the distribution of the encoding distortion to conform to human visual perception, such that in the same compression ratio, image quality may be enhanced to increase encoding efficiency. In addition, the rounding offset is an offset value of a quantization parameter. As illustrated in FIG. 6, the rounding offset is used to control a range of a dead zone 610, so as to influence the number of non-zero reconstructed coefficients.

Please refer back to FIG. 5. The marking circuit 121 may control the quantization circuit 540 to adjust the parameter of the quantization operation with the mark information. For example, the quantization circuit 540 may adjust one or a plurality of parameters (e.g., the quantization step size, the rounding offset and/or other parameters) of the quantization operation according to the mark information 180. Based on the adjusted parameters, the quantization circuit 540 may perform the quantization operation on the CU to generate the quantized frame.

The entropy coding circuit 550 is coupled to the quantization circuit 540 to receive the quantized frame. The entropy coding circuit 550 may perform an entropy coding operation on the quantized frame output by the quantization circuit 540 to generate the encoded video frame. Operation details of the entropy coding circuit 550 may be determined according to a design demand. For example, the entropy coding circuit 550 may perform a run-length coding operation, a Huffman encoding operation, an arithmetic coding operation or other entropy coding operations on the quantized frame provided by the quantization circuit 540. The entropy coding circuit 550 may be a conventional entropy coding circuit or any other entropy coding circuit/element. Finally, the entropy coding circuit 119 generates the encoded video frame as the bit stream output signal Bout.

The inverse quantization circuit 113 performs an inverse quantization operation on the quantized frame provided by the quantization circuit 540. The inverse quantization circuit 113 provides the inverse quantization result to the inverse transformation circuit 114. The inverse transformation circuit 114 performs an inverse transformation operation on the inverse quantization result provided by the inverse quantization circuit 113. The inverse transformation circuit 114 provides the inverse transformation result to the motion estimation circuit 520. Operation details of the inverse quantization circuit 113 and the inverse transformation circuit 114 may be determined according to design demands. For instance, the inverse quantization circuit 113 may be a conventional inverse quantization circuit or any other inverse quantization circuit/element, and the inverse transformation circuit 114 may be a conventional inverse transformation circuit or any other inverse transformation circuit/element.

FIG. 7 is flowchart illustrating a video encoding method according to another embodiment of the invention. The video encoding method can be applied to the video encoding apparatus 100 of FIG. 1 but not limited thereto. For purpose of explanation only, the embodiment of FIG. 7 is described with the video encoding apparatus 100 of FIG. 1. Refer to FIG. 1 and FIG. 7. In step S710, the ROI determination circuit 120 may generate an initial ROI 350 within an original video frame. Step S710 illustrated in FIG. 7 may be derived with reference to the description related to step S220 illustrated in FIG. 2 and thus, will not be repeated. In step S720, the ROI determination circuit 120 may identify one or more ROI objects 361 according to the initial ROI 350. For any video frame (current video frame) among a plurality of sequential video frames following the original video frame, the ROI determination circuit 120 may, in step S730, generate one or more dynamic ROIs 351 for tracking the one or more ROI objects 361 within the current video frame. Step S730 illustrated in FIG. 7 may be derived with reference to the description related to step S240 illustrated in FIG. 2 and thus, will not be repeated.

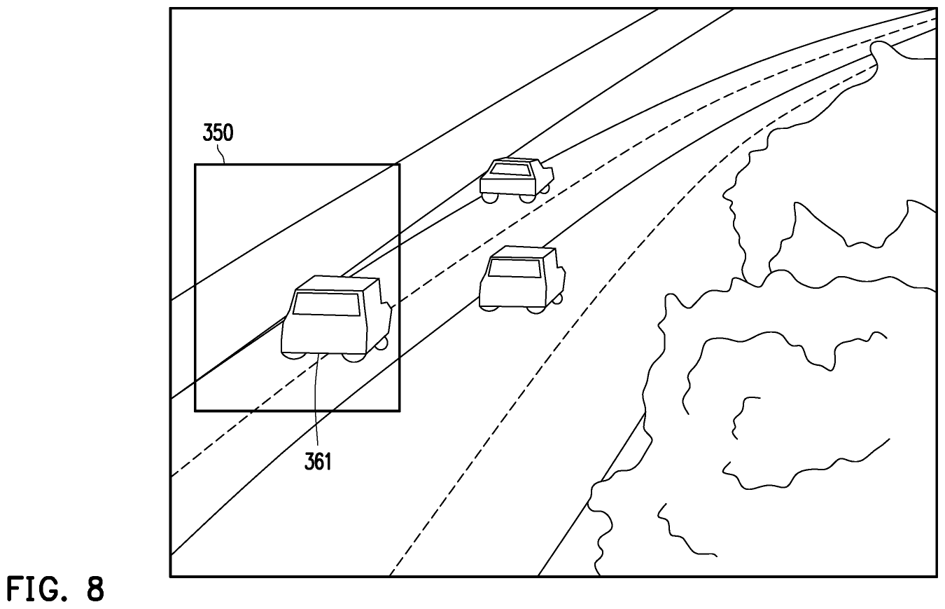

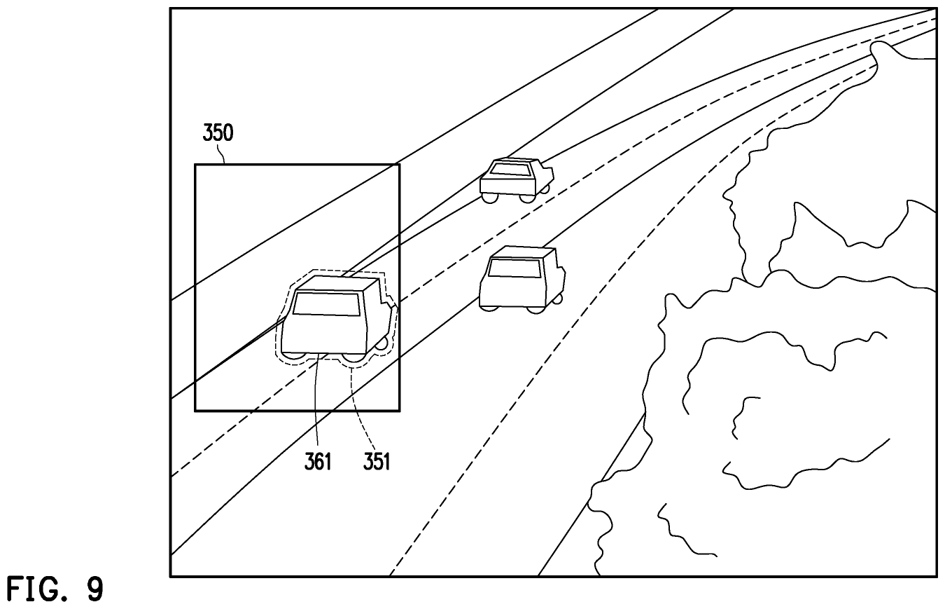

FIG. 8 to FIG. 11 are schematic diagrams illustrating a scenario of the initial ROI 350 according to an embodiment of the invention. The situation shown in FIG. 8 to FIG. 11 is the street view taken by a camera. Referring to FIG. 8, the ROI object 361 may be at least one ROI object (e.g. vehicle) initially not appearing in the initial ROI 350, but then entering into the initial ROI 350. Referring to FIG. 9, when the ROI object 361 enters into the initial ROI 350, the ROI determination circuit 120 may identify the ROI object 361 within the initial ROI 350. Based on the control of the ROI determination circuit 120, the encoding circuit 110 may perform the video encoding operation on the initial ROI 350 by using the first encoding strategy to maintain (or increase) visual quality of the ROI object 361. In order to save network bandwidths and storage spaces, the encoding circuit 110 may perform the video encoding operation on other regions by using the second encoding strategy. Video quality corresponding to the first encoding strategy is more preferable (or higher) than video quality corresponding to the second encoding strategy.

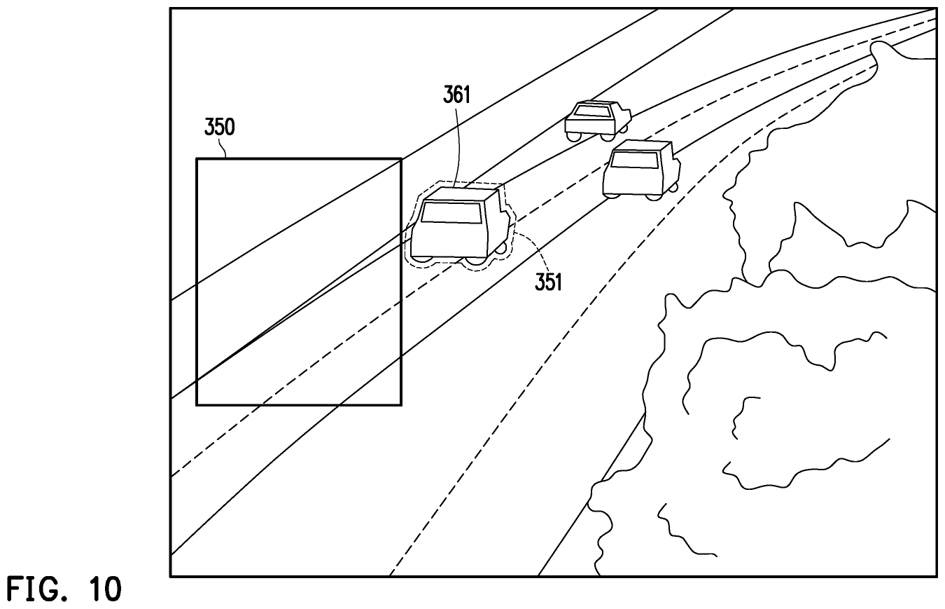

Referring to FIG. 10, the ROI object 361 may be at least one ROI object initially appearing in the initial ROI 350 and then leaving the initial ROI 350. When the ROI object 361 leaves the initial ROI 350, the ROI determination circuit 120 may generate one or more dynamic ROIs (e.g., a dynamic ROI 351 illustrated in FIG. 10) for tracking the ROI object 361 within a current video frame. Based on the control of the ROI determination circuit 120, the encoding circuit 110 may perform the video encoding operation on the dynamic ROI 351 by using the first encoding strategy to maintain (or increase) visual quality of the ROI object 361. In order to save network bandwidths and storage spaces, the encoding circuit 110 may perform the video encoding operation on the initial ROI 350 by using the second encoding strategy because there is no object in the initial ROI 350.

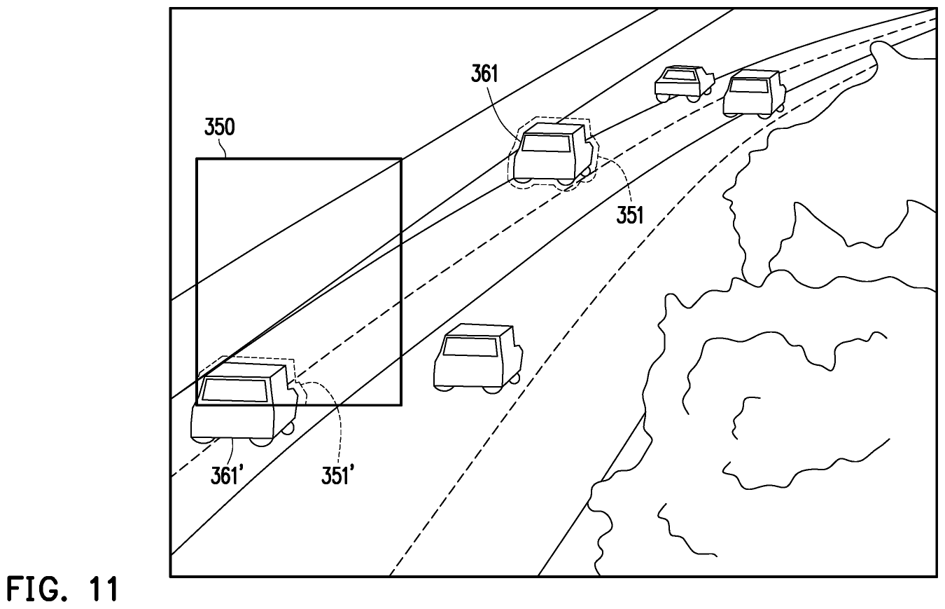

Referring to FIG. 11, the ROI determination circuit 120 may generate the dynamic ROI 351 for tracking the ROI object 361. Another “vehicle” may be at least one ROI object 361′ initially not appearing in the initial ROI 350, but then passing through the initial ROI 350. When the “vehicle” enters into the initial ROI 350, the ROI determination circuit 120 may identify the “vehicle” to serve as another ROI object 361′. The ROI determination circuit 120 may generate another dynamic ROI 351′ for tracking the ROI object 361′ within a current video frame.

It should be noted that in different application scenarios, related functions of the initial ROI determination circuit 10, the video encoding apparatus 100, the encoding circuit 110, the partition circuit 111, the coding circuit 112, the inverse quantization circuit 113, the inverse transformation circuit 114, the ROI determination circuit 120, the marking circuit 121, the CU partition circuit 510, the motion estimation circuit 520, the transformation circuit 530, the quantization circuit 540 and/or the entropy coding circuit 550 may be implemented in a form of software, firmware or hardware by employing general programming languages (e.g., C or C++), hardware description languages (e.g., Verilog HDL or VHDL) or other suitable programming languages. The programming languages capable of executing the functions may be deployed in any computer-accessible media, such as magnetic tapes, semiconductor memories, magnetic disks or compact disks (e.g., CD-ROM or DVD-ROM) or may be delivered through the Internet, wired communication, wireless communication or other communication media. The programming languages may be stored in the computer-accessible media for a processor of the computer to access/execute the programming codes of the software (or firmware). In terms of hardware implementation, by being combined with the aspects disclosed by the embodiments described herein, the functions described herein may be implemented or executed by various exemplary logics, logic blocks, modules and circuits in one or more controllers, microcontrollers, microprocessors, application-specific integrated circuits (ASIC), digital signal processors (DSPs), field programmable gate arrays (FPGAs) and/or other processing units. Moreover, the apparatus and the method of the invention may be implemented by means of a combination of hardware and software. In terms of hardware implementation, by being combined with the aspects disclosed by the embodiments described herein, the functions described herein may be implemented or executed by various exemplary logics, logic blocks, modules and circuits in one or more controllers, microcontrollers, microprocessors, application-specific integrated circuits (ASIC), digital signal processors (DSPs), field programmable gate arrays (FPGAs) and/or other processing units. Moreover, the apparatus and the method of the invention may be implemented by means of a combination of hardware and software.

In light of the foregoing, the video encoding apparatus and the video encoding method provided by the embodiments of the invention can achieve the identification of one or more ROI objects in the ROI by reusing the encoding information generated by the encoding circuit 110. The ROI determination circuit 120 can generate one or more dynamic ROIs for tracking the one or more ROI objects within the current video frame according to the movement of the ROI object once appearing in the initial ROI. According to the movement condition, the size and the shape of the ROI object, the sizes and the shapes of the dynamic ROIs can be dynamically adjusted. The video encoding operation can be performed on the ROI within the current video frame respectively by using different encoding strategies. Thus, the video encoding apparatus and the video encoding method can increase the visual quality of the ROI objects and simultaneously satisfy the design requirements for the software/hardware resources (e.g., encoding operation resources, transmission bandwidths and storage spaces).

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A video encoding apparatus, comprising:
an encoding circuit, configured to perform a video encoding operation on an original video frame to generate an encoded video frame, wherein at least one encoding information is generated by the video encoding operation during an encoding process; and
a region of interest (ROI) determination circuit, coupled to the encoding circuit to receive the encoding information, and configured to obtain an initial ROI within the original video frame and reuse the encoding information generated by the video encoding operation to identify one or more ROI objects according to the initial ROI and generate one or more dynamic ROIs for tracking the one or more ROI objects within a current video frame for any one of a plurality of sequential video frames following the original video frame,
wherein each of the ROI objects appears in the initial ROI within the current video frame or in the initial ROI of at least one video frame in the sequential video frames before the current video frame.

2. The video encoding apparatus according to claim 1, wherein the one or more ROI objects comprises one or more of:
at least one ROI object initially appearing in the initial ROI and staying in the initial ROI;
at least one ROI object initially appearing in the initial ROI and leaving the initial ROI;
at least one ROI object initially not appearing in the initial ROI, but entering and staying in the initial ROI; and
at least one ROI object initially not appearing in the initial ROI but passing through the initial ROI.

3. The video encoding apparatus according to claim 1, wherein the reused encoding information further comprises one or a plurality of texture information of largest coding unit, coding unit depth information, prediction unit size information, and transform unit size information.

4. The video encoding apparatus according to claim 1, wherein the reused encoding information further comprises at least one of motion vector information and advanced motion vector prediction information.

5. A video encoding method comprising:
performing a video encoding operation on an original video frame by an encoding circuit to generate an encoded video frame, wherein at least one encoding information is generated by the video encoding operation during an encoding process;
obtaining an initial ROI within the original video frame; and
reusing the encoding information generated by the video encoding operation to identify one or more ROI objects according to the initial ROI and generate one or more dynamic ROIs for tracking the one or more ROI objects within a current video frame for any one of a plurality of sequential video frames following the original video frame,
wherein each of the ROI objects appears in the initial ROI within the current video frame or in the initial ROI of at least one video frame in the sequential video frames before the current video frame.

6. The video encoding method according to claim 5, wherein the one or more ROI objects comprises one or more of:
at least one ROI object initially appearing in the initial ROI and staying in the initial ROI;
at least one ROI object initially appearing in the initial ROI and leaving the initial ROI;
at least one ROI object initially not appearing in the initial ROI, but entering and staying in the initial ROI; and
at least one ROI object initially not appearing in the initial ROI but passing through the initial ROI.

7. The video encoding method according to claim 5, wherein the encoding information comprises one or a plurality of texture information of largest coding unit, coding unit depth information, prediction unit size information, and transform unit size information.

8. The video encoding method according to claim 5, wherein the encoding information comprises one or a plurality of motion vector information and advanced motion vector prediction information.

9. A video encoding method, comprising:
generating an initial ROI within an original video frame;
identifying one or more ROI objects according to the initial ROI; and
generating one or more dynamic ROIs for tracking the one or more ROI objects within a current video frame for any one of a plurality of sequential video frames following the original video frame,
wherein each of the ROI objects appears in the initial ROI within the current video frame or in the initial ROI of at least one video frame in the sequential video frames before the current video frame.

10. The video encoding method according to claim 9, wherein the one or more ROI objects comprises one or more of:
at least one ROI object initially appearing in the initial ROI and staying in the initial ROI;
at least one ROI object initially appearing in the initial ROI and leaving the initial ROI;
at least one ROI object initially not appearing in the initial ROI, but entering and staying in the initial ROI; and
at least one ROI object initially not appearing in the initial ROI but passing through the initial ROI.
